(19) United States
(12) Patent Application Publication
(10) Pub. No.: US 2019/0191872 A1
(43) Pub. Date: Jun. 27, 2019

(54) CONNECTOR

(71) Applicant: OCTANORM-VERTRIEBS-GMBH FÜR BAUELEMENTE, Filderstadt (DE)

(72) Inventors: Ekkehard DREHER, Sonnenbühl (DE); Andreas DOBER, Stuttgart (DE)

(21) Appl. No.: 16/322,529

(22) PCT Filed: Jul. 11, 2017
(86) PCT No.: PCT/EP2017/067394

§ 371 Date: Feb. 1, 2019

(30) Foreign Application Priority Data
Aug. 2, 2016 (DE) 10 2016 214 254.2

(51) Int. Cl. A47B 47/02; E04B 1/58; E04B 2/74; F16B 12/34; F16B 12/50; A47B 47/03; E04B 2/78; F16B 21/09; F16B 7/04

(52) U.S. Cl. CPC A47B 47/027; E04B 1/5831; E04B 2/7437; F16B 12/34; E04B 2001/5881; A47B 47/03; E04B 2/7827; F16B 21/09; F16B 7/0473; F16B 12/50

(57) ABSTRACT

A connector for connecting a support and a frame disposed so as to be perpendicular thereto. The connector has at least one bolt or hook having an undercut which is configured for engaging in a keyhole-shaped through opening on the frame or support. The dimensions of a front end portion of the bolt or hook are adapted to a wider portion of the through opening, and the dimensions of the undercut are adapted to a narrower portion of the through opening. A housing of the connector is capable of being fixed to the end side of the support or frame, and the at least one bolt or hook is disposed so as to be displaceable parallel with a longitudinal direction of the support or frame into the housing of the connector.

The invention relates to a connector for connecting a support and a frame disposed so as to be perpendicular thereto.

An exhibition construction system in which a so-called tension lock is used as a connector for connecting a support, in other words an upright, and a frame, in other words a beam, disposed so as to be perpendicular thereto is known from European patent document EP 0 976 891 B1. The tension lock has two hooks which engage in an undercut groove in the support. The hooks can be retracted by means of an eccentric in the tension lock such that, on account thereof, an end side of the frame is pulled toward a lateral face of the support. A force-fit which ensures a secure fixing of the frame to the support is created on account thereof. The force-fit between the frame and the support as well as between the hooks of the tension lock and the undercut of the groove can be overcome in the event of very high forces arising. The hooks form the extension in terms of length of a spring in the tension lock. The connection is released in the event of a failure of the spring.

By way of the invention, a connector for connecting a support and a frame disposed so as to be perpendicular thereto is to be improved in terms of the load-bearing capability of the connection.

To this end, a connector having the features of claim 1, and a connection assembly having the features of claim 7, are provided according to the invention. Advantageous refinements of the invention are stated in the dependent claims.

A connector for connecting a support and a frame disposed so as to be perpendicular thereto is provided, in which the connector has at least one bolt or hook having an undercut which is configured for engaging in a keyhole-shaped through opening on the frame or support, wherein the dimensions of a front end portion of the bolt are adapted to a wider portion of the through opening, and the dimensions of the undercut are adapted to a narrower portion of the through opening, wherein a housing of the connector is capable of being fixed to the end side of the support or frame, and wherein the at least one bolt or hook is disposed so as to be displaceable parallel with a longitudinal direction of the support or frame, in particular is disposed so as to be displaceable in the housing of the connector.

In this way, the bolt, or else the entire connector, respectively, can assume a retracted position or assembly position in which the connector, and thus also the bolt, does not protrude beyond the end side of the frame or the support, respectively. On account thereof, a frame can also be inserted between two already fixedly assembled supports, since a length not larger than the spacing between the already fixed supports is required for inserting the frame, said length corresponding to the length of the frame.

In a refinement of the invention, a safety installation which in a secured position fixes the bolt in the narrower portion of the through opening can be provided.

The bolt can be fixed in a form-fitting manner in the keyhole-shaped through opening by means of the bolt and of the keyhole-shaped through opening. This does not apply only to a direction in which the undercut of the bolt is introduced into the narrower portion of the through opening and is also guided out of the latter. The safety installation is provided in order for the bolt to also be fixed in a form-fitting manner in the keyhole-shaped through opening in said direction. On account thereof, the bolt in the secured position of the safety installation is fixed, in particular in a form-fitting manner, in all spatial directions in the narrower portion of the through opening. Even in the case of very high forces which act on the support or frame, the connector reliably absorbs the forces and reliably directs said forces into the support or the frame, respectively by way of the bolts. The at least one bolt or hook can be disposed so as to be rigid or displaceable on the connector. To this end, the bolt or hook can be displaceable relative to a housing of the connector which is fixed to the support or frame. Alternatively, the connector per se is disposed so as to be displaceable in the support or frame.

In a refinement of the invention the safety installation includes the secured position and an assembly position, wherein the safety installation in the assembly position fixes the front end portion of the bolt so as to be in line with the larger portion of the keyhole-shaped through opening.

In that the safety installation in the assembly position fixes the bolt so as to be in line with the comparatively large portion of the keyhole-shaped through opening, an assembly and the disassembly of the connector is significantly facilitated. For example, the safety installation is moved to the assembly position, and the bolts are subsequently displaced from the narrower portion of the keyhole-shaped through opening to the wider portion of the keyhole-shaped through opening. Before the undercut now can latch on the upper periphery of the wider portion of the keyhole-shaped through opening, the safety installation prevents such a movement and aligns the front end portion of the bolt so as to be in line with the wider portion of the keyhole-shaped through opening. The bolts, proceeding from this position, can then be readily extracted from the wider portion of the keyhole-shaped through opening. The safety installation advantageously configures a dual-step detent. The safety installation in the first step is located in the secured position and fixes the bolt in the narrower portion of the through opening. The safety installation in the second step aligns the bolt so as to be in line with the wider portion of the key-hole shaped through opening. For example, the bolt in the second step of the safety installation can be displaced out of the narrower portion of the through opening and into a position in which the front end portion of said bolt is aligned so as to be in line with the wider portion of the keyhole-shaped through opening.

In a refinement of the invention the safety installation has a safety pin which is displaceable parallel with the bolt.

A very reliable and at the same time easily operable safety installation can be achieved by means of a safety pin. The safety pin in the secured position thereof can provide for a form-fit between the safety pin and thus the connector and a receptacle bore for the safety pin in the support or frame.

In a refinement of the invention the safety pin has a step-shaped detent at the front end.

The step in this instance can form a dual-step detent at the front end of the safety pin. When the first or upper face of the detent bears on a safety bore, the bolt by way of the undercut thereof is fixed in the narrower portion of the keyhole-shaped through opening. This forms the secured position of the safety pin. When the second or lower face of the detent stops at the periphery of the safety bore, the bolts can be displaced from the narrower portion of the keyhole-shaped through opening so far in the direction toward the wider portion until the front end portion of the bolt is disposed so as to be in line with the wider portion of the keyhole-shaped through opening. The bolts in this position can then be extracted from the wider portion.

In a refinement of the invention the safety pin in the secured position engages in a safety bore in the support or frame, said safety bore being separate from the keyhole-shaped through openings.

It is enabled in this way that the front end portions of the bolts in the assembly position of the safety pin can be aligned so as to be in line with the wider portion of the keyhole-shaped through opening, since the safety pin per se does not block any part of the keyhole-shaped through opening. The safety bore is configured as an elongate hole, for example. The safety bore as an elongate hole can be configured on the base of an undercut groove of the support or frame. Both the support as well as the frame are expediently configured as a tubular hollow section having an identical cross-section, and are produced as a pultruded aluminum section, for example.

In a refinement of the invention a tension lock which engages in an undercut groove in the support or frame is provided.

Additional securing in the form of a friction-fit between the frame and the support can be established by means of such a tension lock. For example, the frame can also be rapidly and readily preassembled in the envisaged position by means of the tension lock, and the bolt can only be subsequently fixed in the keyhole-shaped through openings. Of course, an assembly is also possible in the reverse manner. The tension lock in this instance can ensure a gap-free bearing of the end side of the frame on the lateral face of the support. The provision of a tension lock which in the assembled state pretensions the end side of the frame in relation to the lateral face of the support enables pretensioning of the bolts in the keyhole-shaped through openings to be dispensed with. The bolt by way of the undercut thereof can especially also in the assembly position be disposed with play in the narrower portion of the through opening. As soon as a force is exerted on the bolt, the bolt is braced in relation to the periphery of the keyhole-shaped through opening. In order for a visual appeal of the connection between the frame and the support to be obtained, and also in order to avoid any rattling of the connection, a force-fit by means of the tension lock can in this instance be additionally established between the frame and the support.

In a refinement of the invention a housing of the connector is capable of being fixed to the end side of the support or frame.

The connector by means of a housing can be reliably fixed to the support or frame. The housing is configured as a profile or extension, for example, the external side thereof being configured so as to match an internal side of the hollow section for the supports and frames. On account thereof, the housing can be push-fitted in a very simple manner into the hollow profile which forms the support and/or the frame. On account thereof, the housing of the connector is fixed in directions of movement perpendicular to a longitudinal axis of the support or frame solely by push-fitting.

In a refinement of the invention the bolt by means of a tensioning installation can be braced between the connector and the narrower portion of the keyhole-shaped through opening.

In this way, a gap between an end side of the frame and the lateral face of the support can be reduced to zero by means of the tensioning installation, and an additional force-fit can be generated. An additional tension lock can optionally be omitted in the case of such a design embodiment of the connector. A tensioning installation for the bolt can be embodied by means of an eccentric, for example. Just like the hooks of the tension lock can be moved by means of an eccentric, this is also possible in the case of the bolts.

In a refinement of the invention the bolt is disposed on an adapter which is disposed so as to be displaceable in the housing of the connector.

In this way, the housing of the connector per se can be disposed so as to be secure and immovable in the frame or support. The retraction function of the bolts can be implemented by way of a displacement of the adapter in the housing of the connector per se.

In a refinement of the invention four bolts are provided.

It has been demonstrated that forces in all spatial directions as well as moments about all spatial directions can be reliably absorbed by the bolts and directed onward into the frame and/or support when four bolts which are in particular disposed on the corner points of a rectangle or square are provided.

In a refinement of the invention the tension lock is disposed so as to be substantially centric to the four bolts.

Such an arrangement of the tension lock has proven very advantageous, also for reasons of space.

Further features and advantages of the invention are derived from the claims and from the description hereunder of preferred embodiments of the invention in conjunction with the drawings. Individual features of the various embodiments described and illustrated herein can be combined with one another in an arbitrary manner without exceeding the scope of the invention. In the drawings:

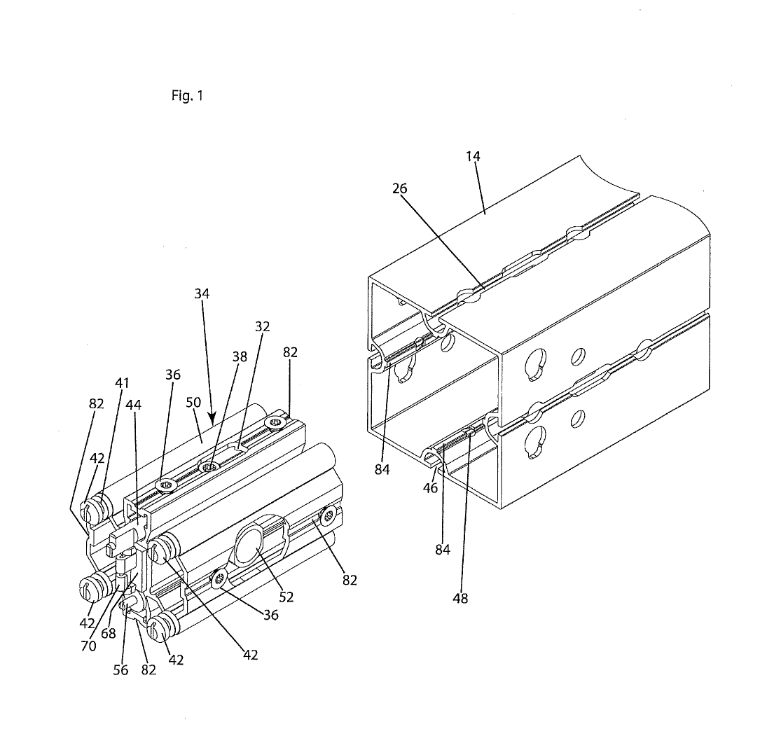

FIG. 1 shows a partially sectioned connector according to the invention and a frame illustrated in portions in an exploded illustration;

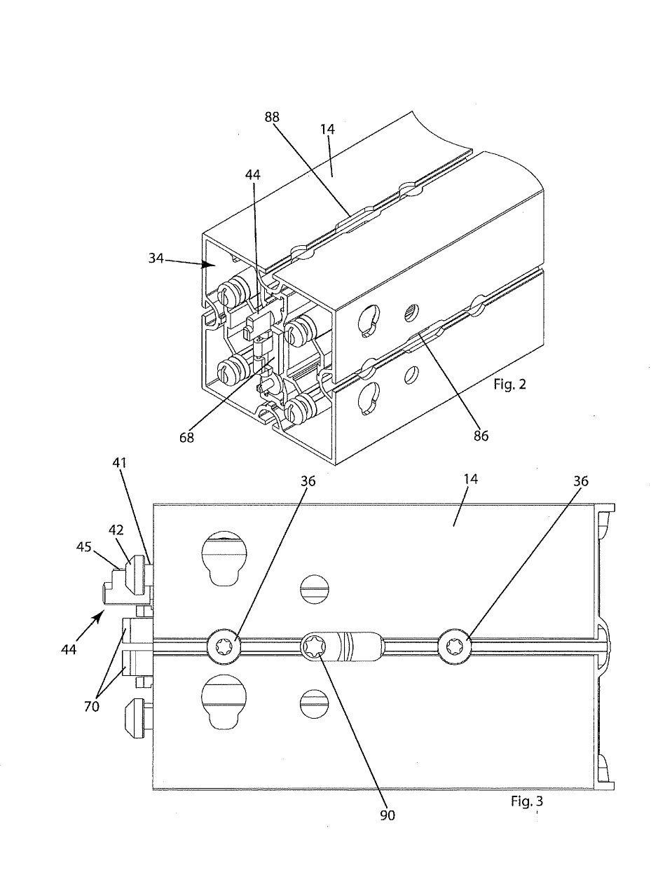

FIG. 2 shows the connector and the frame of FIG. 1 in the assembled state in a secured position;

FIG. 3 shows a side view of the connector and the frame of FIG. 2 in the secured position;

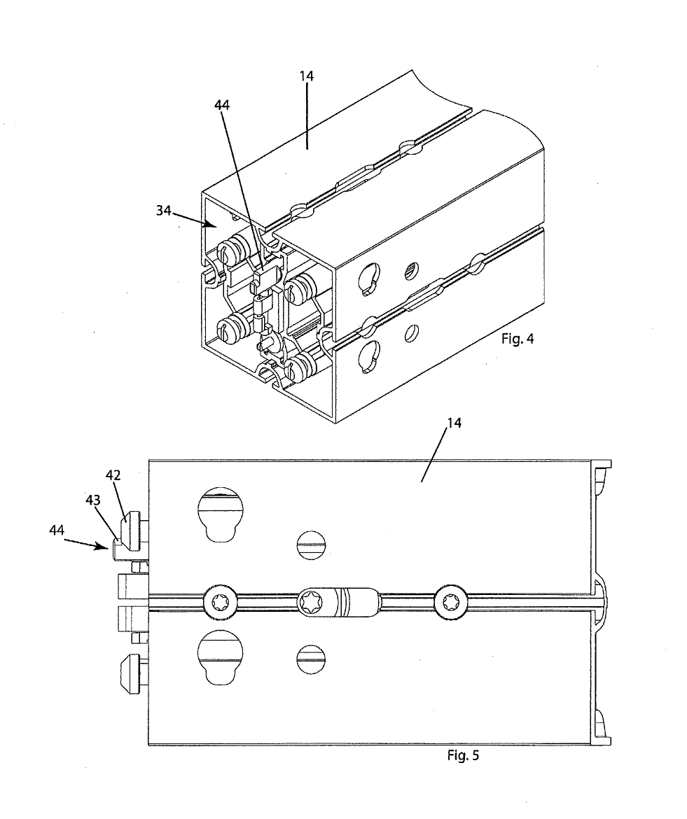

FIG. 4 shows the connector and the frame of FIG. 2 in an assembly position;

FIG. 5 shows a side view of the connector and the frame of FIG. 4 in the assembly position;

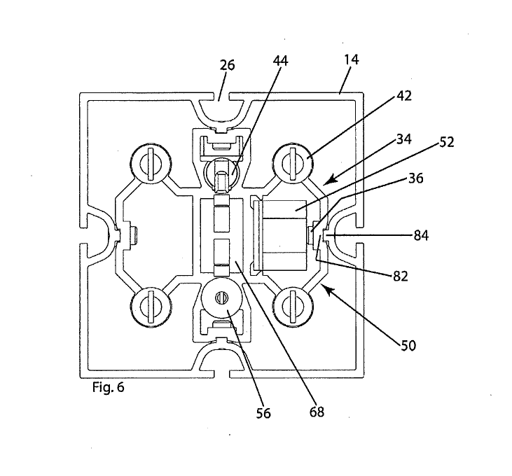

FIG. 6 shows a front view of the connector and the frame of FIG. 4;

FIG. 7 shows the connector of FIG. 1 in an enlarged illustration;

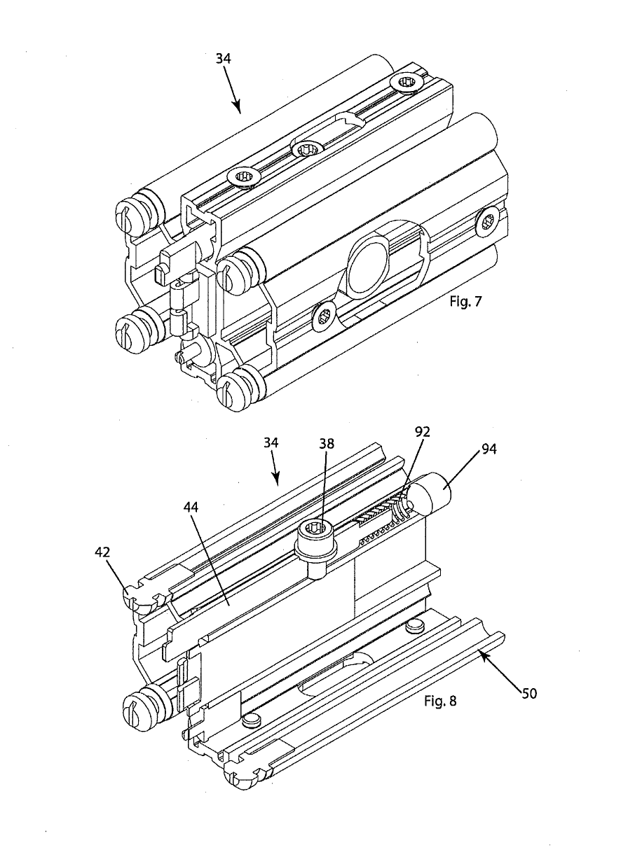

FIG. 8 shows a partially sectioned view of the connector of FIG. 7;

FIG. 9 shows a front view of the connector of FIG. 7;

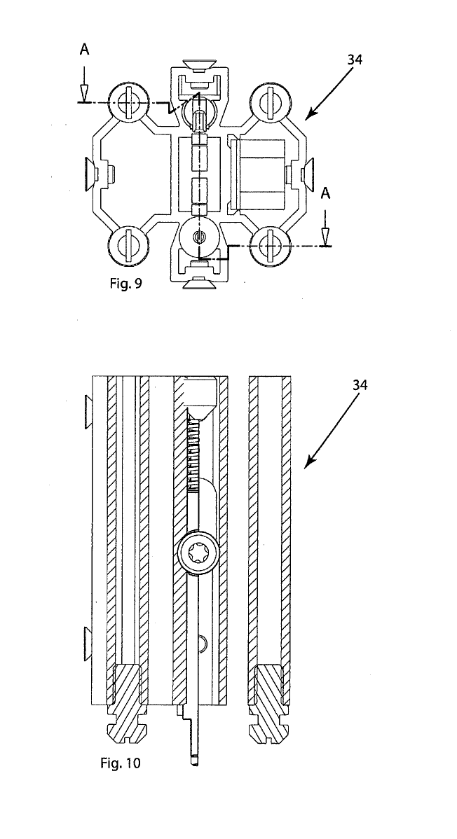

FIG. 10 shows a plan view of the connector sectioned along the line A-A in FIG. 9;

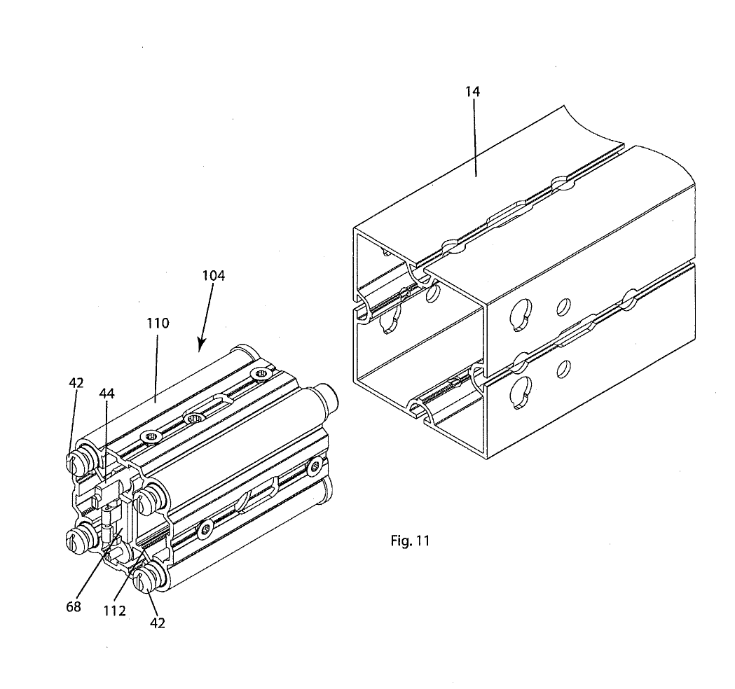

FIG. 11 shows a connector according to a further embodiment of the invention, and a frame illustrated in portions, in an exploded illustration;

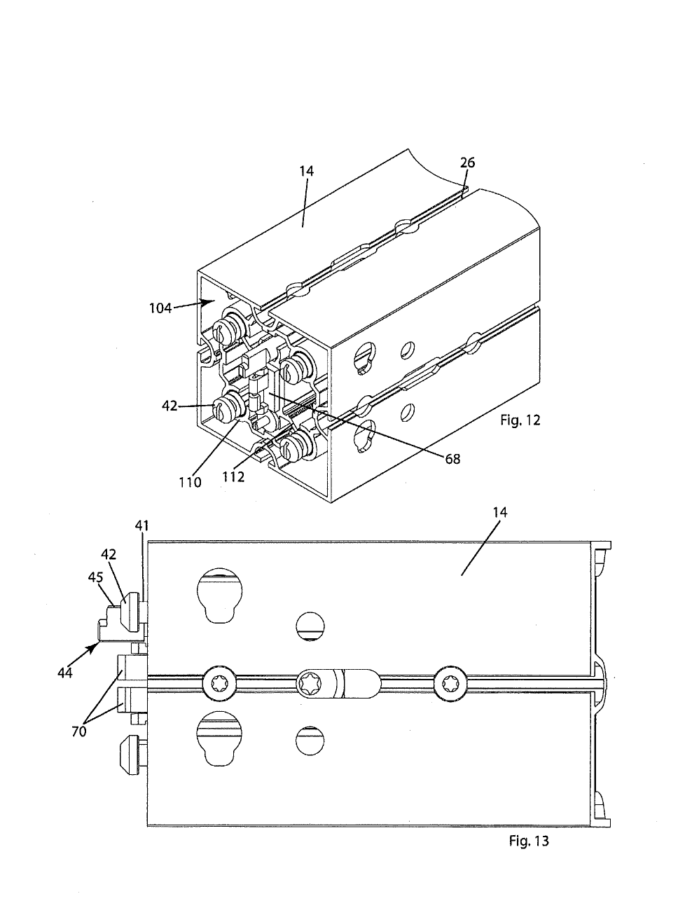

FIG. 12 shows the connector and the frame of FIG. 11 in the assembled state in a secured position;

FIG. 13 shows a side view of the connector and the frame of FIG. 12 in the secured position;

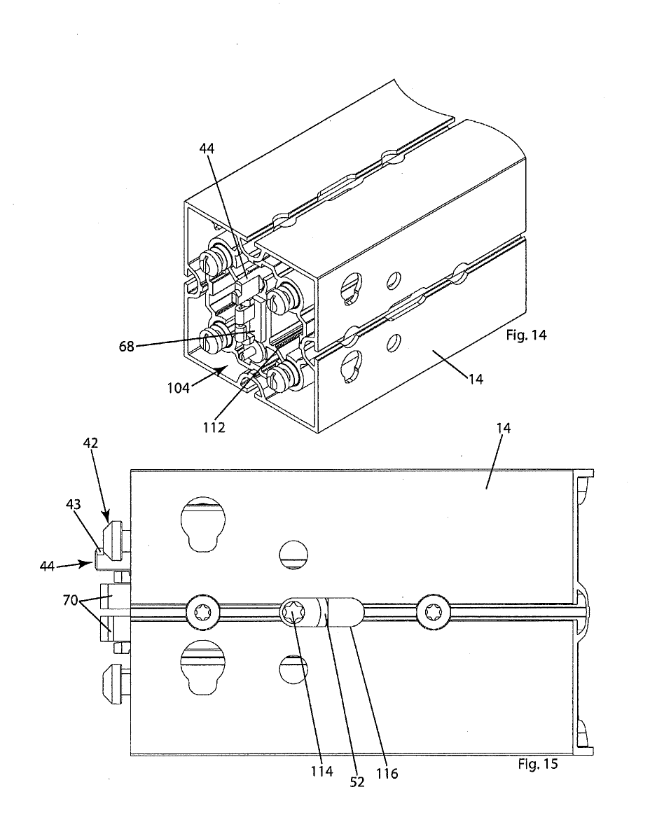

FIG. 14 shows the connector and the frame of FIG. 12 in an assembly position;

FIG. 15 shows the connector and the frame of FIG. 14 in a side view, in the assembly position;

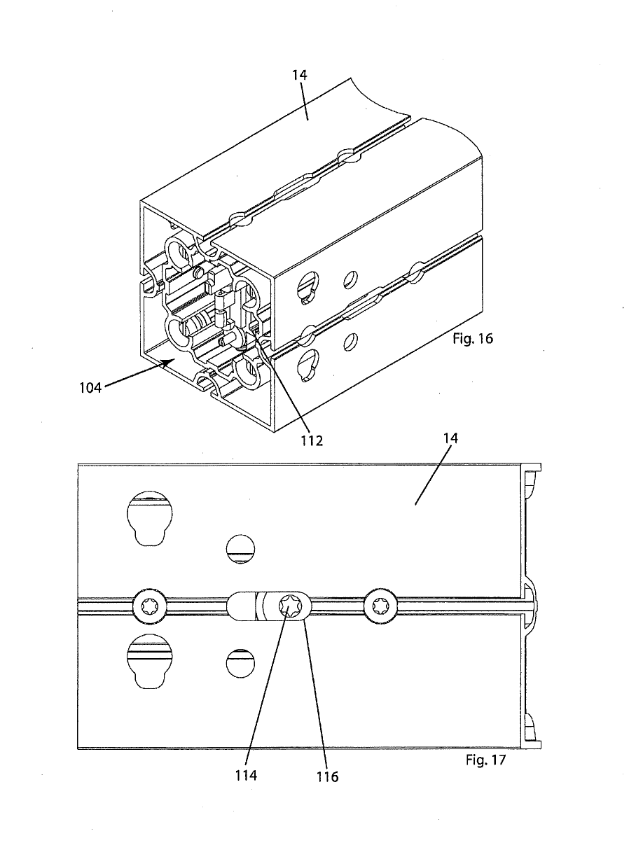

FIG. 16 shows the connector and the frame of FIG. 14 in a retracted position;

FIG. 17 shows a side view of the connector and the frame of FIG. 16;

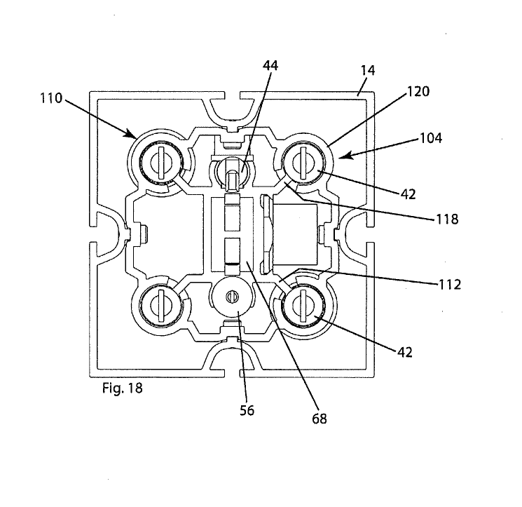

FIG. 18 shows a front view of the connector and the frame of FIG. 12;

FIG. 19 shows an enlarged illustration of the connector of FIG. 11;

FIG. 20 shows a partially sectioned view of the connector of FIG. 19;

FIG. 21 shows a front view of the connector of FIG. 19;

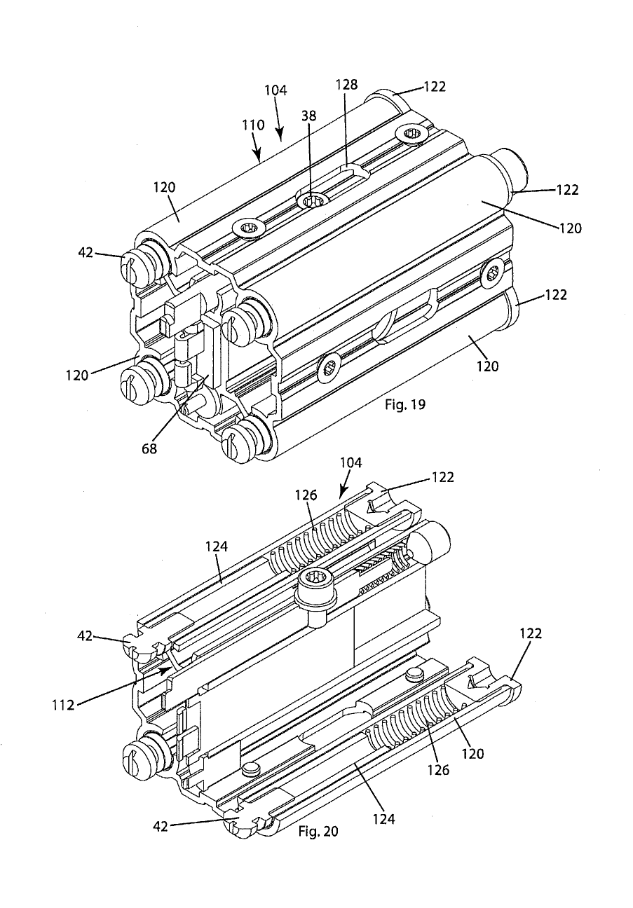

FIG. 22 shows a plan view of the connector of FIG. 21, sectioned along the line A-A;

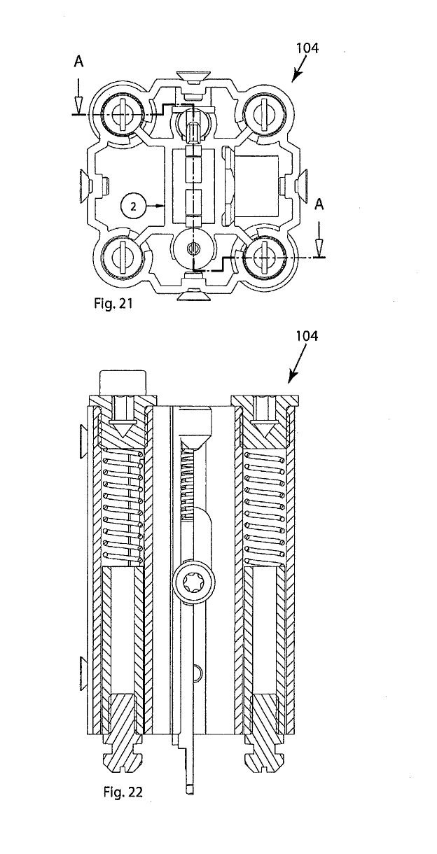

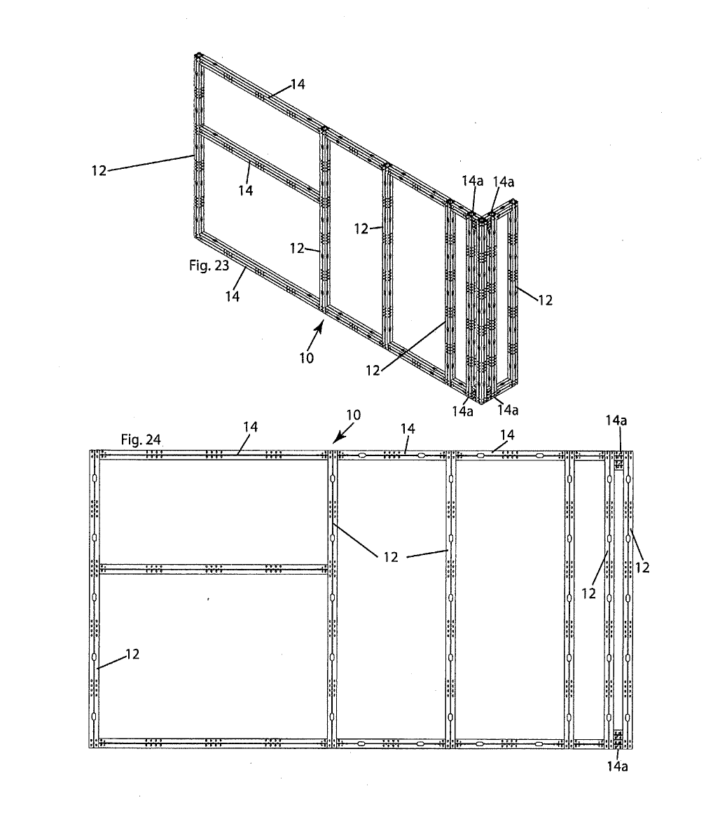

FIG. 23 shows an isometric illustration of a framework from obliquely below, said framework being constructed from supports and frames which are connected to one another by means of the connector according to the invention;

FIG. 24 shows a side view of the framework of FIG. 23;

FIG. 25 shows a side view of a support and frame connected to one another, from the framework of FIG. 23;

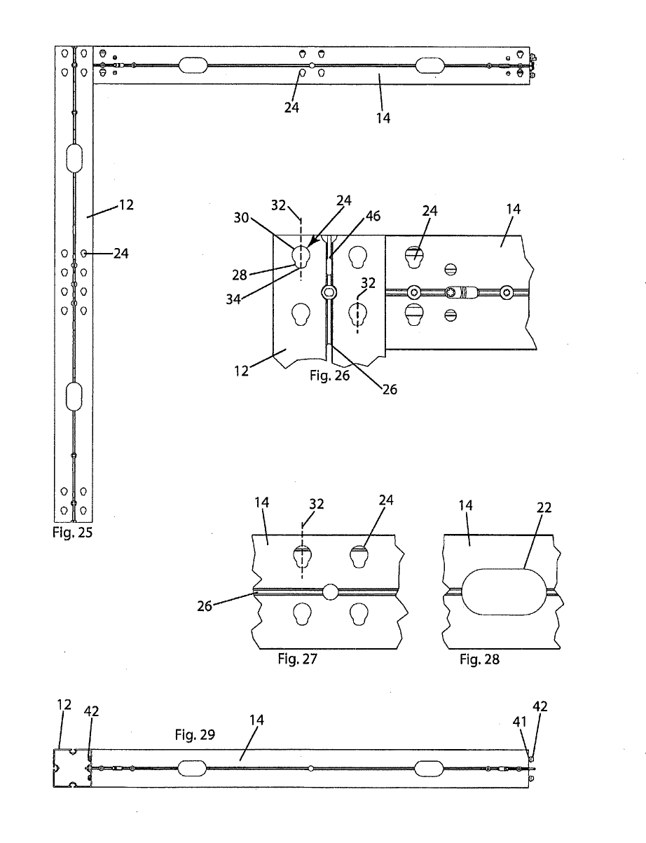

FIG. 26 shows an enlarged illustration of portions of a connection region between the support and the frame of FIG. 25;

FIG. 27 shows an enlarged illustration of portions of the frame of FIG. 25;

FIG. 28 shows a further enlarged illustration of portions of the frame of FIG. 25;

FIG. 29 shows a plan view of the arrangement having the support and the frame of FIG. 25;

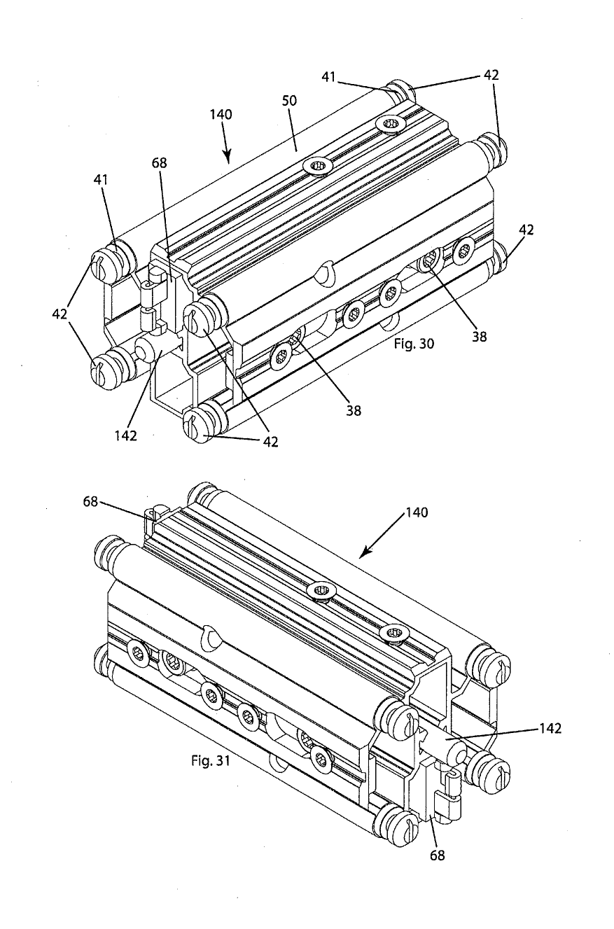

FIG. 30 shows a connector according to a further embodiment of the invention, obliquely from the front; and

FIG. 31 shows the connector of FIG. 30 obliquely from the rear.

The illustration of FIG. 1 shows a connector 34 which is provided for being push-fitted into the end side of a frame 14 and to be fixed therein. The frame 14 is configured as a a tubular hollow profile, the interior thereof being configured so as to match a housing 50 of the connector. The connector 34 has four bolts 42 which protrude beyond the end side of the housing 50. Each of the bolts 42 has an annular groove 41 which is formed between a head of the bolt and an annular flange of the bolt, and which forms an undercut. The bolts, by means of a threaded portion (not visible in FIG. 1) are screwed into an annular receptacle duct in the housing 50. The housing 50, as is also the frame 14, is configured as a profile, in particular as a pultruded or extruded aluminum profile.

The connector 34 has a safety pin 44 which in a receptacle duct of the housing 50 can be displaced in and counter to a longitudinal direction of the connector. An adjustment screw 38 is provided for displacing the safety pin 44. The safety pin 44 by means of a compression spring (not visible in FIG. 1) which is disposed in the receptacle duct is pretensioned to a secured position illustrated in FIG. 1. The adjustment screw 38 can be moved between two terminal detents which are formed by the periphery of an elongate hole 32 in the housing 50. The connector 34 is moreover provided with a tension lock 68 which is push-fitted into a centric receptacle chamber in the housing 50 and which can be activated by means of an eccentric (not visible in FIG. 1). The eccentric is accessible by way of a bush 52. To this end, a side wall of the housing is provided with a through opening 54 which in FIG. 1 is illustrated so as to be significantly larger than implemented in reality, so as to render the bush 52 visible. The tension lock 68 has two hooks 70 which can be hooked into an undercut groove of a support. The connector can moreover be provided with a guide pin 56 which likewise protrudes beyond an end side of the housing 50 and which, like the hooks 70, is provided for engaging in an undercut groove of a support. To this end, the support has at least one undercut groove 26 as can be seen on the frame 14.

The bolts 42 are provided for engaging in keyhole-shaped through openings of a support. To this end, a group of four keyhole-shaped through openings is provided on the support, cf. FIG. 26. A group of four keyhole-shaped through openings is provided in all lateral faces of the support 12, this however not being visible in FIG. 26. The frame 14 is also provided with groups of four keyhole-shaped through openings, cf. FIG. 25. The frame 14 on the left and right end thereof in FIG. 25 is in each case provided with one group of two keyhole-shaped through openings 24 which conjointly with further keyhole-shaped through openings on the support 12 then again form one group of four keyhole-shaped through openings 24 into which the bolts 42 of the connector 34 can then engage. In the case of the embodiment illustrated, four bolts 42 are provided on the connector 34, and in a matching manner thereto, groups of at least four keyhole-shaped through openings 24 are in each case provided on the support 12 or the frame 14, respectively. However, in the context of the invention the provision of a single bolt 42 which in this instance also engages in a single keyhole-shaped through opening 24 is also sufficient.

As can be seen in FIG. 26 and FIG. 27, the keyhole-shaped through openings 24 have in each case a wider portion 30 and a narrower portion 28. The wider portion 30 has a segment-shaped periphery and in terms of the diameter thereof is adapted to the diameter of the front end of the bolt 42, such that the bolts 42 can be introduced in the wider portion 30 of the keyhole-shaped through openings 24. The dimension of the groove 41 on the bolts 42 is adapted to the dimensions of the narrower portion 28 of the keyhole-shaped through openings 24. When the bolts, after having been introduced into the wider portion 30 in FIG. 26, are moved downward, parallel with the central axis 32 of the keyhole-shaped through opening 24, the free end of the bolt 42 thus engages behind the periphery of the narrower portion 28 of the keyhole-shaped through opening 24, since the periphery comes to lie in the groove 41. The bolt 42 in this instance by way of a portion of the base of the annular groove 41 bears on the lower periphery of the narrower portion 28. The bolt by the lateral delimitations of the narrower portion 28 is blocked in relation to any displacement of the bolt 42 in the lateral direction relative to the keyhole-shaped through opening 24. The lower delimitation 34, embodied in a rectilinear manner, of the keyhole-shaped through opening 24 ensures a form-fitting fixing of the bolt 42 in relation to any downward movement. The lower delimitation 34 herein is embodied so as to be rectilinear in order to enable a certain lateral movement of the bolt 42 for equalizing tolerances within the narrower portion 28 of the keyhole-shaped through opening 24.

When the bolt by way of the groove 41 thereof is located in the narrower portion 28 of the keyhole-shaped through opening 24, said bolt is thus fixed in a form-fitting manner in the direction of movement toward the left, toward the right, and downward, cf. FIG. 26. Only an upward movement, thus in the direction toward the wider portion 30, is still possible. Such a movement is in this instance prevented by the safety pin 44 which in portions engages in the safety bore 46 in the support 12, cf. FIG. 26. The safety bore 46 in the case of the embodiment illustrated is embodied as an elongate hole. The connector 34 in such a secured position of the safety pin 44 in a form-fitting manner is thus fixed in all spatial directions to the support 12. On account thereof, the frame 14 which is connected to the support 12 by means of the connector 34 is likewise reliably secured on the support 12. The tension lock 68, the hooks 70 thereof engaging in the undercut of the groove 26 on the support 12, moreover ensures a force-fit between the end side of the frame 14 and the assigned lateral face of the support 12, and also ensures that no play whatsoever remains between the end side of the frame 14 and the lateral face of the support 12.

FIG. 27 shows a group of four keyhole-shaped through openings 24 in the frame 14. By means of the connector 34, two frames can be connected to one another by means of said keyhole-shaped through openings.

It can be seen in the illustration of FIG. 29 that the bolts 42 in the assembled state by way of the front end portion thereof protrude into the interior of the support 12. Two of the four bolts 42 can likewise be seen at the right end of the frame 14 in FIG. 29, and it can also be seen that the groove 41 still protrudes beyond the end side of the frame 14 such that said groove in the assembled state can engage in the narrower portions 28 of the keyhole-shaped through openings 24.

It can furthermore be seen in FIG. 1 that the housing 50 of the connector 34 has four grooves 82 which are in each case mutually spaced apart by 90°. In a manner matching thereto, the frame 14 has four strip-shaped protrusions 84 which protrude into the interior of the frame 14 and which ensure longitudinal guiding of the housing 50 after push-fitting into the frame 14. As has already been explained, the housing 50 of the connector 34, after push-fitting into the frame 14 is already fixed to the extent that said housing 50 can still only be displaced in and counter to the longitudinal direction of the frame 14. Fixing screws 36 which can be screwed into the threaded bores in the housing 50, which emanate from the base of the grooves 82, are provided in order for the housing 50 to be fixed relative to the frame 14. After the push-fitting of the connector 34 into the frame 14, the fixing screws 36 are introduced into countersunk bores 48 on the base of the undercut grooves 26 of the frame 14 and screwed into the threaded bores in the housing 50. On account thereof, the housing 50 is then reliably fixed in the frame 14. When the countersunk bores 48 are embodied as elongate holes, the connector 34 after the location of the fixing screws 36 can be displaced in and counter to the longitudinal direction of the frame 14, for example in order for the end side of the bolts 42 for assembling the frame to be retracted level with the end side of the frame 14 or behind the end side of the frame 14.

The connector 34 and the frame 14 in the illustration of FIG. 2 are illustrated in the assembled state. An eccentric of the tension lock 68 is now accessible by way of a lateral bore 86 in the frame 14. As has already been explained, the safety pin 44 by means of the adjustment screw 38 can be displaced in and counter to the longitudinal direction of the frame 14, wherein the adjustment screw 38 is accessible by way of an elongate hole 88 in the upper side of the frame 14.

The illustration of FIG. 3 shows a secured position of the safety pin 44. It can be seen in the side view of FIG. 3 that the safety pin 44 in the secured position thereof protrudes beyond the front end of the bolts 42. An upper side 45 of the safety pin 44 in the secured position stops at the upper periphery of the safety bore 46, cf. FIG. 26, and on account thereof prevents the bolts 42 being moved out of the narrower portions 28 of the keyhole-shaped through openings 24. Rather the bolts are fixed such that said bolts by way of the angular grooves 41 thereof are disposed in the narrower portions 28 of the keyhole-shaped through openings 24. The connector 34 in this secured position is thus fixed in a form-fitting manner in the keyhole-shaped through openings 24 of the support 12.

It can furthermore be seen in FIG. 3 that the hooks 70 of the tension lock 68 protrude beyond the end side of the frame 14. As has already been explained, the hooks 70 by means of activating an eccentric 90 can be moved in and counter to the longitudinal direction of the frame 14, thus from right to left, or from left to right, respectively, in the illustration of FIG. 3. On account thereof, the hooks can engage in the undercut of the groove 26 in the support 12, cf. FIG. 26 and FIG. 29, so as to on account thereof pull the end side of the frame 14 toward the end face of the support 12 and to establish a force-fit therebetween.

The illustration of FIG. 4 shows the connector 34 and the frame 14 in an assembly position of the safety pin 44. As can be seen in FIG. 5, the safety pin 44 now protrudes less far beyond the end side of the frame 14 as was the case in the secured position of FIG. 3. The upper side 45 of the safety pin 44 in the secured position of FIG. 3 protrudes beyond the front end of the bolts 41. In the assembly position of FIG. 5 only a face of the step-shaped detent 43 still protrudes beyond the front end of the bolts 42, said face being disposed so as to be parallel with the displacement direction of the safety pin, thus so as to be horizontal in the installed position of the frame. In this assembly position of FIG. 5, consequently only the step-shaped detent 43 still engages in the safety bore 46 on the base of the groove 26 of the frame 12, cf. FIG. 26. Since the step-shaped detent 43 in the view of FIG. 5 lies lower than the upper side 45 of the safety pin 44, cf. also FIG. 3, the frame 14 can now be pushed further upward relative to the support 12, until the horizontal face of the step-shaped detent 43 thus stops at the upper delimitation of the safety bore 46, cf. FIG. 26. In this position, the front ends of the bolts 42 are now aligned so as to be in line with the wider portions 30 of the keyhole-shaped through openings 24. The frame 14 in this instance can be removed from the support 12 to the right in a simple manner, cf. FIG. 26, since the front ends of the bolts 42 can be guided out of the wider portions 30 of the keyhole-shaped through openings 24.

The assembly position of FIG. 5 of the safety pin 44 is achieved in that the securing screw 38, cf. FIG. 1, is displaced to the rear, thus to the top right in FIG. 1, until said securing screw 38 stops at the delimitation of the elongate hole 32 that lies at the top right in FIG. 1.

The illustration of FIG. 6 shows a front view of the connector 34 installed in the frame 14. It can be readily seen in this view how the strip-shaped protrusions 84 of the frame 14, which protrude into the interior of the tubular hollow section which forms the frame 14, engage in the grooves 82 of the housing 50 of the connector 34 and on account thereof secure the housing 50 in the frame 14. As has already been explained, the fixing screws 36 in this instance serve for finally fixing the housing 50 relative to the frame 14. The housing 50 is configured as a hollow section and has the four receptacle ducts into which the bolts 42 are screwed. A central chamber having a rectangular cross section serves for receiving the tension lock 68. The safety pin is received so as to be displaceable in a further receptacle duct having an approximately circular cross section. The guide pin 56 can be disposed on that side of the tension lock 68 that is opposite the safety pin.

The illustration of FIG. 7 shows the connector 34 of FIG. 1 in an enlarged illustration.

FIG. 8 shows the connector 34 so as to be partially sectioned. It can be seen in this view that a compression spring 92 is disposed within the receptacle duct for the safety pin 44, said compression spring 92 being supported on a closure plug 94 of the receptacle duct, on the one hand, and on the rear side of the safety pin 44, on the other hand. The compression spring 92 pretensions the safety pin 44 to the secured position illustrated in FIG. 3 and FIG. 7. When the safety pin 44 is retracted to the assembly position illustrated in FIG. 5, the adjustment screw 38 to this end has to be moved counter to the force of the spring 92. In the assembled state of the frame 14 on the support 12, cf. FIG. 26, the securing screw 38 can be completely screwed in so as to on account thereof fix the safety pin 44 in the secured position.

It can be furthermore seen in the illustration of FIG. 8 how the bolts 42 by way of the threaded portion thereof are screwed into the receptacle ducts in the housing 50.

FIG. 9 shows a front view of the connector 34 of FIG. 7. FIG. 10 shows a view of the connector 34 which is sectioned along the line A-A in FIG. 9.

The illustration of FIG. 11 shows a connector 104 according to a further embodiment of the invention, as well as the frame 14, wherein the frame 14 and the connector 104 are illustrated in the exploded state, thus prior to the connector 104 being inserted into the end side of the frame 14.

The connector 104 differs from the connector 34 of FIG. 1 in that a retraction function of the bolts 42 is additionally implemented. Such a retraction function is required when the frame 14 has to be installed between two already fixedly assembled supports which are no longer displaceable in the longitudinal direction of the frame, cf. also FIG. 23 and FIG. 24, since the spacing between the two supports in this instance corresponds exactly to the length of the frame 14. In order for the frame 14 in this instance to be moved to the envisaged position between the two supports 12, the bolts 42 must not protrude beyond the end sides of the frame 14 since the frame could otherwise not be placed between the two supports 12.

In order for such a retraction function to be implemented, a housing 110 which is fixed relative to the frame 14 is provided in the case of the connector 104. An adapter 112 is received so as to be displaceable in the longitudinal direction in the housing 110, the bolts 42 as well as the tension lock 68 and the safety pin 44 being fastened to said adapter 112.

The illustration of FIG. 12 shows the connector 104 and the frame 14 in a secured position. The adapter 112 in said secured position is placed relative to the housing 110 such that the bolts 42 extend so far beyond the end side of the frame 14, cf. FIG. 13, that the grooves 14 and the undercuts formed by the grooves also still lie in front of the end side of the frame 14. The hooks 70 of the tension lock 68 also protrude beyond the end side of the frame 14 and, on account thereof, can engage behind the undercut of the groove 26 of a support 12, cf. FIG. 26. The safety pin 44 is located in the secured position thereof, in which the upper side 45 of said safety pin 44 protrudes beyond the front side of the bolts 42 and on account thereof stops at the upper delimitation of the safety bore 46, cf. FIG. 26. On account thereof, the bolts 42 in said secured position are fixed relative to the keyhole-shaped through openings 24 such that the grooves 41 are disposed in the respective narrower portions 28 of the keyhole-shaped through openings 24. The safety pin 44 herein is received so as to be displaceable in the adapter 112. The adapter 112, by means of the adjustment screw 38 (not visible in FIG. 13) of the safety bolt 44, can be fixed relative to the housing 110 and thus also relative to the frame 14.

FIG. 14 shows the connector 104 and the frame 14 in an assembly position of the safety pin 44, and FIG. 15 shows a side view of the connector 104 and the frame 14 in the assembly position.

As can be seen in FIG. 15, the bolts 42 by way of the front end thereof protrude beyond the end side of the frame 14 and are located in the same position as has already been shown and explained by means of FIGS. 12 and 13. By contrast, the safety pin 44 relative to the adapter 112 has been displaced to the rear so far that only a face of the step-shaped detent 43 still protrudes beyond the front end of the bolts 42, said face being disposed so as to be parallel with the displacement direction of the safety pin 44, thus so as to be horizontal in the assembled state of the frame 14. The frame 14 in this position can be displaced so far upward relative to the support 12, cf. FIG. 26, until the horizontal face of the step-shaped detent 43 stops at the upper delimitation of the safety bore 46 and, on account thereof, simultaneously aligns the front ends of the bolts 42 so as to be in line with the wider portions 26 of the keyhole-shaped through openings 30.

It is to be established by means of FIG. 15 that the eccentric screw 114 which is accessible by way of the bush 52 and by way of which the hooks 70 of the tension lock 68 can be displaced in and counter to the longitudinal direction of the frame 14 is located in the position at the left end of an elongate hole 116. By means of the eccentric screw 114, especially by way of a socket wrench which engages in the eccentric screw 114, the adapter 112 can be displaced such that the latter in FIG. 15 is moved to the right until the tool plugged into the eccentric screw 114 stops at the right end of the elongate hole 116. This retracted position of the adapter 112 is illustrated in FIGS. 16 and 17.

By way of a comparison of FIGS. 14 and 16, or 15 and 17, respectively, it can immediately be seen that the adapter 112 has now been displaced into the frame 14 so far that no part of the connector 114 protrudes any longer beyond the end side of the frame 14. In order for this retraction of the adapter 112 to be effected, a tool plugged into the eccentric screw 114 has been displaced relative to the frame so far until the tool stops at the right end in FIG. 17, thus the end that is remote from the end side, of the elongate hole 116, as has already been explained. The frame 14 in this position can be readily pushed between two already fixedly disposed supports, even when the spacing between the two supports corresponds exactly to the length of the frame 14, cf. also FIG. 23 and FIG. 24.

The illustration of FIG. 18 shows a front view of the connector 104 in the assembled state in the frame 14. The adapter 112 is configured as a profile and has four receptacle ducts for screwing-in the bolts 42, a central receptacle chamber for the tension lock 68, a receptacle duct for the safety pin 44, and opposite the receptacle duct for the safety pin 44 a screw-in potential for the guide pin 56. The adapter 112 has an H-type shape, since the receptacle ducts for the bolts 42 are located at the end of webs which extend away from a central part of the adapter 112 which contains the receptacle chamber for the tension lock 68. The receptacle duct for the safety pin is formed by an approximately C-shaped protrusion which extends from the central part having the receptacle chamber for the tension lock 68. The receptacle duct for the safety pin 44 is disposed between two receptacle ducts for in each case one bolt 42. The receptacle, or the receptacle duct, respectively, for the optionally provided guide pin 56 is also disposed between two receptacle ducts for in each case one bolt 42.

On account of the receptacle ducts for the bolts 42 being disposed at the free end of the webs 118, said receptacle ducts which have a circular-cylindrical external wall can be enclosed across an angle of approximately 300° by a matching guide duct 120 in the housing 110. The receptacle duct for the bolts 42 on the adapter 112 is thus received so as to be longitudinally displaceable in the guide duct 120 of the housing 110. For example, a total of four such guide ducts 120 are provided in the housing 110 such that the adapter 112 is mounted in the housing 110 so as to be only displaceable in the longitudinal direction, thus out of the drawing plane and into the drawing plane in the illustration of FIG. 18. The housing 110 in this instance is fixed so as to be immovable relative to the frame 14, as has already been explained.

The illustration of FIG. 19 shows the connector 104 of FIG. 11 in an enlarged illustration. The four guide ducts 120 on the housing 110 can be seen in this view, said four guide ducts 120 in each case forming the corners of the housing 110. Each of the guide ducts 120 at the end thereof opposite the bolt 42 is in each case closed by way of a plug 122.

It can be seen in the partially sectioned illustration of the connector 104 in FIG. 20 that one compression spring 126 is in each case provided between the plug 120 and the receptacle ducts 124 for the bolts 42 on the adapter 112. The adapter 112 by means of the compression springs 126 is thus pretensioned in a direction away from the plugs 120. A detent herein is guaranteed by the adjustment screw 38 which stops at the front end of the elongate hole 128 in the housing 110.

As has already been described by means of FIGS. 15 and 17, the adapter 112 can be retracted relative to the housing 110, thus in the direction toward the plugs 122, in that a tool is plugged into the eccentric screw 114 of the tension lock 68 and said tool is then moved in the direction toward the plugs 122.

The illustration of FIG. 21 shows a front view of the connector 104.

FIG. 22 shows a plan view of the connecter 104 sectioned along the line A-A in FIG. 21.

The illustration of FIG. 23 shows a framework 10 in an L-shape in a view from obliquely below, said framework 10 being composed of a total of eight vertically disposed supports 12 and a total of fifteen horizontally disposed frames 14.

FIG. 24 shows a side view of the framework 10 of FIG. 23. The frames 14 at the respective end sides thereof are connected to lateral faces of the supports 12. These connections are in each case implemented by way of one of the connectors 34, 104. As has already been explained, the connector 34 can be used when there is sufficient space for displacing the frame 14 in the horizontal direction relative to the support. The connector 104 is used when the spacing between the two already fixed and immovable supports corresponds exactly to the length of the frame 14.

All frames 14, with the exception of the frames 14a of which a total of four pieces are provided on the framework 10, are configured in an identical manner in as far as said frames 14 are formed from the same tubular hollow profile which has already been illustrated and explained in FIG. 1. By contrast, the frames 14a have double the cross section of the other frames 14, wherein the internal cross section of the section is also twice present. Consequently, the frames 14a are formed in a simplified manner in that two of the hollow profiles for the frames 14 are placed on top of one another and are connected to one another in the region of the bearing face thereof. The frames 14a are therefore of a different configuration since the length of the frames 14a corresponds substantially to the length of the connectors 34, 104. In order for the supports 12 to be able to be connected at such a small mutual spacing, two connectors 34, 104 therefore have to be disposed in the frames 14a so as to be offset in the height direction. The connection principle when connecting the frames 14a to the connectors 34, 104 is however unchanged in relation to that of the frames 14.

The illustration of FIG. 25 shows in an exemplary manner a support 12 and a frame 14 from the framework 10 of FIGS. 23 and 24 that is connected in an orthogonal manner to said support 12. Groups of a plurality of keyhole-shaped through openings 24 which serve for hooking the bolts 42 of the connectors 34, 104 can in each case be seen. The groups can in each case have 2, 4, 6, or 8 through openings 24.

It has indeed already been explained by means of FIG. 26 which illustrates an enlarged portion in the connection region of the support 12 and of the frame 14, how the connectors 34, 104 are inserted into the keyhole-shaped through openings 24 and are then displaced in order for a secure connection between the frame 14 and the support 12 to be established. In the case of the supports 12, the central axes 32 of the keyhole-shaped through openings 24 are aligned so as to be parallel with the longitudinal direction and thus also parallel with the grooves 26.

The illustration of FIG. 27 shows an illustration of a portion of the frame 14. The keyhole-shaped through openings 24 in the case of the frames 14 are aligned such that the central axis 32 of said through openings 24 is disposed so as to be perpendicular to the longitudinal direction of the frame 14 and thus also perpendicular to the groove 26 in the frame 14. On account thereof, a first frame 14 can be connected in a perpendicular manner to a further frame 14, if required.

FIG. 28 shows a further illustration of a portion of the frame 14, wherein a cable conduit opening 22 which serves for routing cables in or out is disposed in this portion.

FIG. 29 shows a plan view of the support 12 and the frame 14 of FIG. 25.

FIG. 30 shows a connector 140 according to a further embodiment of the invention from obliquely above. The connector 140 in principle is configured so as to be very similar to the connector 34 of FIG. 1, but is provided as a double-sided connector. The connector 140 is specially provided for connecting to one another two supports 12 or frames 14 that are disposed so as to be very close to one another, for example the corner support 12 of FIG. 24 to the adjacent support 12. The connector 140 herein is pushed into a frame 14 which is as long as the frame 14a illustrated in FIG. 24, but is of only half the height.

The connector 140 at the front and rear end face thereof is in each case provide with 4 bolts 42 which have in each case one undercut. As described, the bolts 42 are in each case hooked into a keyhole-shaped through opening 24 in the supports 12, or the frames 14, respectively.

Moreover, one tension lock 68 is in each case provided on the front end side and the rear end side of the connector 140, cf. also FIG. 31. Moreover, one safety bolt 142 which by means of in each case one assigned adjustment screw 38 can be advanced or retracted is in each case provided on the front and rear end side of the connector 140. The function of the double-sided connector 140 of FIGS. 30 and 31 corresponds to the function of the connector 34 of FIG. 1 and is not explained again. In order for two supports 12 or frames 14 to be connected at a spacing which corresponds to the spacing between the undercut grooves 41 of the bolts 42 at the front end face and the undercut grooves 41 of the bolts 42 at the rear end face of the connector 140, the connector is pushed into a frame 14 or a support 12, the length of said frame 14 or said support 12 corresponding to the length of the housing 50 of the connector 140. The bolts 42 are then in each case hooked into a keyhole-shaped through opening. The tension locks 68 in this case serve for additionally bracing the supports 12 or frames 14, respectively, that are disposed at a mutual spacing. The connection can then be secured in a form-fitting manner against unintentional releasing by advancing the safety bolt 142.

1. A connector for connecting a support and a frame disposed so as to be perpendicular thereto, wherein the connector has at least one bolt or hook having an undercut which is configured for engaging in a keyhole-shaped through opening on the frame or support, wherein the dimensions of a front end portion of the bolt or hook are adapted to a wider portion of the through opening, and the dimensions of the undercut are adapted to the narrower portion of the through opening, wherein a housing of the connector is capable of being fixed to the end side of the support or frame, and wherein the at least one bolt or hook is disposed so as to be displaceable parallel with a longitudinal direction of the support or frame in the housing of the connector.

2. The connector as claimed in claim 1, wherein the bolt or hook in a retracted position thereof does not protrude beyond an end side of the support or frame.

3. The connector as claimed in claim 1, wherein the at least one bolt or hook by means of a tensioning installation can be braced between the connector and the narrower portion of the keyhole-shaped through opening.

4. The connector as claimed in claim 1, wherein the bolt or hook is disposed on an adapter which is disposed so as to be displaceable in the housing of the connector.

5. The connector as claimed in claim 1, wherein four bolts or hooks are provided.

6. The connector as claimed in claim 5, wherein the tension lock is disposed so as to be substantially centric to the four bolts or hooks.

7. The connector as claimed in claim 1, wherein a safety installation which in a secured position fixes the bolt or hook in the narrower portion of the through opening is provided, and in that the safety installation includes the secured position and an assembly position, wherein the safety installation in the assembly position aligns the front end portion of the bolt or hook so as to be in line with the wider portion of the keyhole-shaped through opening.

8. The connector as claimed in claim 7, wherein the safety installation has a safety pin which is displaceable parallel with the bolt or hook.

9. The connector as claimed in claim 8, wherein the safety pin has a step-shaped detent at the front end.

10. The connector as claimed in claim 8, wherein the safety pin in the secured position engages in a safety bore in the support or frame, said safety bore being separate from the keyhole-shaped through openings.

11. The connector as claimed in claim 1, wherein a tension lock which engages in an undercut groove in the support or frame is provided.

12. A connection assembly having at least one support, at least one frame disposed so as to be perpendicular thereto, and at least one connector as claimed in claim 1.
